(19) United States
(12) Patent Application Publication
(10) Pub. No.: US 2013/0000759 A1
(43) Pub. Date: Jan. 3, 2013

(54) MICROFLUIDIC DEVICE AND EXTERNAL PIEZOELECTRIC ACTUATOR

(75) Inventors: Kevin P. Killeen, Woodside, CA (US); Reid A. Brennen, San Francisco, CA (US); Dustin Chang, Mountain View, CA (US); Storrs T. Hoen, Brisbane, CA (US)

(73) Assignee: AGILENT TECHNOLOGIES, INC., Loveland, CO (US)

(21) Appl. No.: 13/408,131

(22) Filed: Feb. 29, 2012

Related U.S. Application Data
(63) Continuation-in-part of application No. 13/173,901, filed on Jun. 30, 2011.

(51) Int. Cl. F04B 49/03; F16K 31/04

(52) U.S. Cl. 137/565.16; 251/129.01

(57) ABSTRACT

A fluid pumping device includes a piezoelectric actuator externally coupled to a microfluidic device. The piezoelectric actuator has an axial displacement along a lengthwise axis responsive to application of a bias voltage. The axial displacement of the piezoelectric actuator operates one of an internal valve and an internal pump chamber of the microfluidic device.

This application is a continuation-in-part of U.S. patent application Ser. No. 13/173,901, filed Jun. 30, 2011, in the United States Patent and Trademark Office, the disclosure of which is hereby incorporated by reference.

### BACKGROUND

Reciprocating micropumps are used for various applications, such as loading samples in liquid chromatography instruments. A typical micropump may include an inlet valve, a pump chamber and an outlet chamber, where the pump chamber pumps fluid by alternately expanding to receive the fluid through the inlet valve and contracting to expel the fluid through the outlet valve. Of course, “fluid” refers to liquids and/or gases. Generally, a reciprocating motion of a diaphragm or membrane forming a portion of the pump chamber causes the pump chamber to expand and contract. Various techniques for creating the reciprocating motion incorporate use of thermopneumatic, electrostatic, pneumatic and piezoelectric actuators, for example. Performance of conventional micropumps is generally limited by the largest size bubble that can be tolerated.

Conventional micropumps with piezoelectric actuators typically have a lateral strain configuration, which includes a flat piezoelectric disk having a first side attached to the diaphragm of a pump chamber and a second side free to extend in response to an electrical signal. A lengthwise axis of the piezoelectric disk is substantially parallel to a top surface of the diaphragm, such that the piezoelectric disk effectively lies flat on the diaphragm. When a bias voltage is applied, the piezoelectric disk contracts laterally, causing a bending moment between the piezoelectric disk and the diaphragm. The bending moment warps the diaphragm, causing fluid within the pump chamber to be expelled. While this configuration is relatively easy to fabricate and produces large displacements, it cannot produce large pressures. For example, a conventional lateral strain micropump may produce about 0.06 bar to about 2.0 bar of pressure.

The inlet and outlet valves may be actively actuated in a similar manner to the pump chamber, e.g., using a piezoelectric actuator, or the inlet and outlet valves may be passive check valves. However, passive check valves are typically inappropriate for high pressure piezoelectrically actuated micropumps because the amount of fluid pumped in each cycle is limited and a finite fluid volume is required to actuate the check valves. Piezoelectrically actuated valves may be limited to differential pressures of approximately 3 bar, for example. Many piezoelectrically actuated inlet and outlet valves rely on bending mode actuators in order to achieve a larger range of motion.

There are some examples of conventional micropumps having piezoelectric actuators that expand and contract longitudinally, as opposed to laterally. Again, such micropumps typically include a flat piezoelectric disk with a lengthwise axis that is substantially parallel to the top surface of the diaphragm, such that the piezoelectric disk effectively lies flat on the diaphragm. However, when a bias voltage is applied, the piezoelectric disk extends downward vertically, causing a bending moment to warp the diaphragm. However, such configurations are difficult to fabricate and exhibit poor ON/OFF flow ratios. Also, in one example, a thermally balanced piezoelectric actuator is situated inside the valve chamber. Although this micropump is cable of producing high ON/OFF flow rate ratios and may seal against relatively high pressures, the piezoelectric actuator is placed in tension and the working fluid in the valve chamber comes in contact with the piezoelectric actuator. Accordingly, the micropump is not appropriate for high pressure systems in which a variety of fluids may be used, creating a risk of contamination. Further, because the piezoelectric actuator is internal to the valve chamber, the valve chamber cannot be removed or replaced with respect to the piezoelectric actuator.

### SUMMARY

In a representative embodiment, a fluid transfer device includes a piezoelectric actuator externally coupled to a microfluidic device. The piezoelectric actuator has an axial displacement along a lengthwise axis responsive to application of a bias voltage, the axial displacement of the piezoelectric actuator operating one of an internal valve and an internal pump chamber of the microfluidic device.

In another representative embodiment, a fluid transfer device includes a microfluidic device having a first valve and a first piezoelectric actuator coupled to the microfluidic device. The first valve has a valve chamber, and operation of the first valve enables fluid to enter or exit the valve chamber through a port. The first piezoelectric actuator is configured to extend along a first lengthwise axis in response to application of a first bias voltage to close the first valve, and to contract along the first lengthwise axis in response to a reduction of the applied first bias voltage to open the first valve, where the first piezoelectric actuator is external to the microfluidic device.

In another representative embodiment, a fluid transfer device includes a planar microfluidic device, a first piezoelectric actuator, a second piezoelectric actuator and a third piezoelectric actuator. The planar microfluidic device includes an inlet valve, a pump chamber in fluid communication with the inlet valve via an inlet port, and an outlet valve in fluid communication with the pump chamber via an outlet port. The first piezoelectric actuator is external to the microfluidic device and mechanically coupled to the inlet valve, the first piezoelectric actuator having a first axial displacement responsive to selective application of a first bias voltage, causing the inlet valve to close and open via the mechanical coupling, respectively. The second piezoelectric actuator is external to the microfluidic device and mechanically coupled to the pump chamber, the second piezoelectric actuator having a second axial displacement responsive to selective application of a second bias voltage, causing the pump chamber to compress and expand via the mechanical coupling, respectively. The third piezoelectric actuator is external to the microfluidic device and mechanically coupled to the outlet valve, the third piezoelectric actuator having a third axial displacement responsive to selective application of a third bias voltage, causing the outlet valve to close and open via the mechanical coupling, respectively. Thus, fluid is drawn from a device inlet port connected to the inlet valve into the pump chamber through the inlet port when the inlet valve is open, the pump chamber is expanding, and the outlet valve is closed. Likewise, the fluid is expelled from the pump chamber through the outlet port to a device outlet port connected to the outlet valve when the inlet valve is closed, the pump chamber is compressing, and the outlet valve is open.

In another representative embodiment, a microfluidic device includes one of a pump chamber and a valve chamber defined, in part, by a flexible membrane, and a piezoelectric actuator coupled to the microfluidic device. The piezoelectric actuator is configured to extend along a lengthwise axis in response to application of a bias voltage, the value of the bias voltage moving the flexible membrane to a position that compresses the one of the pump chamber and the valve chamber for restricting flow of a fluid through the microfluidic device at a desired flow rate. The piezoelectric actuator is external to the microfluidic device.

### BRIEF DESCRIPTION OF THE DRAWINGS

The illustrative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIGS. 1A and 1B are cross-sectional diagrams illustrating a fluid transfer device, according to a representative embodiment.

FIGS. 2A, 2B and 2C are cross-sectional diagrams illustrating a fluid transfer device, according to a representative embodiment.

FIG. 3 is a cross-sectional diagram illustrating a multiple valve fluid transfer device, according to a representative embodiment.

FIGS. 4A and 4B are cross-sectional diagrams illustrating a multiple valve, integrated fluid transfer device, according to a representative embodiment.

FIGS. 5A and 5B are cross-sectional diagrams illustrating multiple valve microfluidic devices of integrated fluid transfer devices, according to representative embodiments.

FIG. 6 is a cross-sectional diagram illustrating an actuating device, according to a representative embodiment.

FIG. 7 is a cross-sectional diagram illustrating a multiple valve, integrated fluid transfer device, incorporating the actuating device of FIG. 6, according to a representative embodiment.

FIGS. 8A and 8B are cross-sectional diagrams illustrating a valve chamber having a raised pattern, according to a representative embodiment.

FIGS. 9A and 9B are cross-sectional diagrams illustrating a pump chamber having a raised pattern, according to a representative embodiment.

FIGS. 10A and 10B are cross-sectional diagrams illustrating a pump chamber having a depressed pattern, according to a representative embodiment.

FIGS. 11A and 11B are cross-sectional diagrams illustrating a pump chamber having a gas permeable membrane, according to a representative embodiment.

FIGS. 12A and 12B are cross-sectional diagrams illustrating a multiple valve, integrated fluid transfer device having continuous flow, according to a representative embodiment.

### DETAILED DESCRIPTION

In the following detailed description, for purposes of explanation and not limitation, illustrative embodiments disclosing specific details are set forth in order to provide a thorough understanding of embodiments according to the present teachings. However, it will be apparent to one having had the benefit of the present disclosure that other embodiments according to the present teachings that depart from the specific details disclosed herein remain within the scope of the appended claims. Moreover, descriptions of well-known devices and methods may be omitted so as not to obscure the description of the example embodiments. Such methods and devices are within the scope of the present teachings.

Generally, it is understood that the drawings and the various elements depicted therein are not drawn to scale. Further, relative terms, such as “above,” “below,” “top,” “bottom,” “upper,” “lower,” “left,” “right,” “vertical” and “horizontal,” are used to describe the various elements' relationships to one another, as illustrated in the accompanying drawings. It is understood that these relative terms are intended to encompass different orientations of the device and/or elements in addition to the orientation depicted in the drawings. For example, if the device were inverted with respect to the view in the drawings, an element described as “above” another element, for example, would now be “below” that element. Likewise, if the device were rotated 90 degrees with respect to the view in the drawings, an element described as “vertical,” for example, would now be “horizontal.”

Various representative embodiments provide a planar microfluidic device coupled with one or more external piezoelectric actuators to produce a fluid pumping device or fluid transfer device, such as a micropump. For example, the microfluidic device may include an inlet, a first valve chamber, a pumping chamber, a second valve chamber and an outlet. A first piezoelectric actuator is configured to open and close a first valve in the first valve chamber, a second piezoelectric actuator is configured to compress and expand the pumping chamber, and a third piezoelectric actuator is configured to open and close a second valve in the third valve chamber. Each of the first, second and third piezoelectric actuator is configured to extend and contract axially, along an elongated lengthwise axis, to interact with the corresponding valve or pumping chamber.

By closing the second valve, opening the first valve and expanding the pump chamber, fluid is drawn in from the inlet. By closing the first valve, opening the second valve and compressing the pump chamber, fluid is expelled from the device. Accordingly, the fluid transfer device is able to pump fluid and produce substantial pressure, for example, in a range of about 50 bar to over about 1000 of pressure. The various embodiments may be used for high performance liquid chromatography (HPLC) instruments, for example, for loading samples and/or as the analytical pump itself

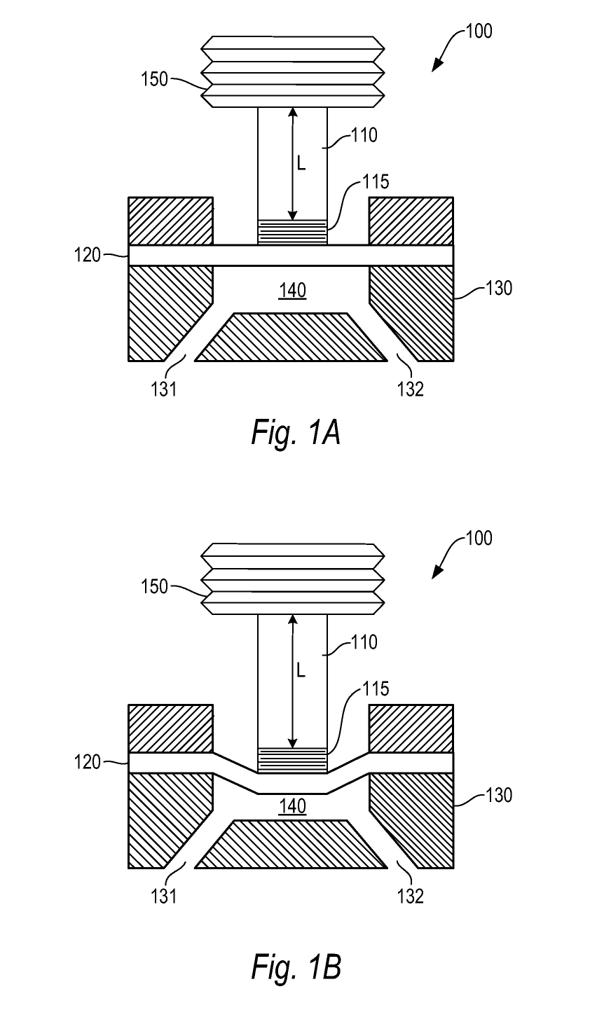

FIGS. 1A and 1B are cross-sectional diagrams illustrating a fluid transfer device, including a piezoelectric actuator, according to a representative embodiment.

Referring to FIGS. 1A and 1B, fluid transfer device 100 includes planar microfluidic pump device 130, which includes internal pump chamber 140, inlet port 131 and outlet port 132. The microfluidic pump device 130 also includes flexible membrane 120, which forms the upper wall of the internal pump chamber 140. As discussed in detail below, the flexible membrane 120 is bent (or deformed) downward from its initial position (shown in FIG. 1A) to a flexed position (shown in FIG. 1B), expelling fluid from the pump chamber 140 through the outlet port 132, and is unbent upward from its bent position to its initial position, drawing fluid into the pump chamber 140 through the inlet port 131, to provide a pumping action. The fluid may be a liquid or a gas, as would be apparent to one of ordinary skill in the art. The microfluidic pump device 130 may be formed of a durable material, such as stainless steel or other metal material. Alternatively, the microfluidic pump device 130 may be formed of another material, such as glass, ceramic, silicon or a polymer, such as polyimide, polycarbonate or other plastic, without departing from the scope of the present teachings. Likewise, the flexible membrane 120 may be formed of a flexible metal, such as stainless steel, for example. Alternatively, the flexible membrane 120 may be formed of materials such as polymers, glass, ceramics, and metals or some combination thereof, without departing from the scope of the present teachings. In various embodiments, the internal surfaces of the microfluidic pump device 130 (e.g., walls of the pump chamber 140) are coated with a non-reactive coating, which may include a polymer, ceramic, glass, metal or fluoropolymer coating, for example.

The fluid transfer device 100 further includes piezoelectric actuator 110 externally coupled to the microfluidic pump device 130 via boss 115. The piezoelectric actuator 110 is externally coupled in that it is arranged entirely outside the pump chamber 140, and therefore is not in contact with the working fluid contained in or passing through the pump chamber 140. The piezoelectric actuator 110 may therefore be used in high pressure systems, for which there is otherwise a risk of contamination of the piezoelectric actuator 110 if it were not external to the microfluidic pump device 130. In various configurations, the external piezoelectric actuator 110 also may be detachable from the microfluidic pump device 130. Therefore, the external coupling of the piezoelectric actuator 110 allows easy replacement of the microfluidic pump device 130.

In the depicted configuration, the piezoelectric actuator 110 has an elongated shape, where the length is greater than the width, as indicated in FIGS. 1A and 1B. A lengthwise axis L of the piezoelectric actuator 110 is arranged substantially perpendicular to the upper surface (flexible membrane 120) of the microfluidic pump device 130. This differs from a conventional system in which a lengthwise axis of the piezoelectric actuator is parallel to the upper surface of the microfluidic device, such that it essentially lies flat on the microfluidic device. Although the piezoelectric actuator 110 is shown as having a substantially rectangular shape, it is understood that any of a variety of elongated shapes, having a lengthwise L may be incorporated without departing from the scope of the present teachings.

The piezoelectric actuator 110 has an axial displacement along the lengthwise axis L responsive to application of a bias voltage. For example, upon application of the bias voltage (e.g., 100V), the piezoelectric actuator 110 extends from a contracted position (shown in FIG. 1A) to an extended position (shown in FIG. 1B), forcing the flexible membrane 120 to bend downward into the pump chamber 140 a distance corresponding to the axial displacement via the boss 115. The downward movement of the flexible membrane 120 thus compresses the pump chamber 140, such that the pump chamber 140 transitions from an expanded position (shown in FIG. 1A) to a compressed position (shown in FIG. 1B). The movement from the expanded position to the compressed position causes the pump chamber 140 to expel fluid from the outlet port 132. The boss 115 provides a transition from the cross-section of the piezoelectric actuator 110 (e.g., rectangular) to a circular region over which pressure is applied to the flexible membrane 120.

Similarly, when the bias voltage is reduced (e.g., 0V is applied), which includes removal of the bias voltage, the piezoelectric actuator 110 contracts from the extended position (shown in FIG. 1B) to its initial contracted position (shown in FIG. 1A), allowing the flexible membrane 120 of the microfluidic pump device 130 to unbend and move upward out of the pump chamber 140. The unbending movement of the flexible membrane 120 thus expands the pump chamber 140, such that the pump chamber 140 transitions from its compressed position (shown in FIG. 1B) to its initial expanded position (shown in FIG. 1A). The movement from the compressed position to the expanded position causes the pump chamber 140 to draw in fluid through the inlet port 131. The application of the bias voltage to the piezoelectric actuator 110 is repeated in a periodic fashion to cause the pump chamber 140 to alternately expand and compress, causing the fluid to be drawn in and expelled through the inlet port 131 and the outlet port 132, respectively, providing fluid pumping functionality.

The depicted illustrative embodiment, the fluid transfer device 100 also includes high-stiffness actuator 150 coupled to the piezoelectric actuator 110. The high-stiffness actuator 150 may be a low compliance, slow speed actuator configured to adjust a position of the piezoelectric actuator 110 in relation to the microfluidic pump device 130, e.g., to ensure that the piezoelectric actuator 110 is properly positioned with respect to the microfluidic pump device 130. In addition, the high-stiffness actuator 150 provides a barrier that prevents the piezoelectric actuator 110 from extending in an upward direction upon application of the bias voltage, causing the axial displacement to occur in the downward direction to more efficiently bend the flexible membrane 120. Like the piezoelectric actuator 110, the high-stiffness actuator 150 is external to the microfluidic pump device 130, allowing the microfluidic part to be easily replaced. The high-stiffness actuator 150 may be adjusted, for example, to accommodate any slow thermal misalignment that occurs between the piezoelectric actuator 110 and the microfluidic pump device 130.

In the depicted example, the high-stiffness actuator 150 is implemented as an adjustable screw-drive configured to adjust the position of the piezoelectric actuator 110 along the lengthwise axis L by moving the screw-drive clockwise or counter-clockwise directions, accordingly. The screw-drive may be realized by coupling a rotary motor to fine-pitched adjustable screw, for example, such as a rotary stepper motor. Of course, other types of high-stiffness actuator 150 may be incorporated, or the high-stiffness actuator 150 may be omitted altogether, or without departing from the scope of the present teachings. Other possible implementations of the high-stiffness actuator 150 include a pneumatic actuator, a thermal actuator or a wedge drive, for example.

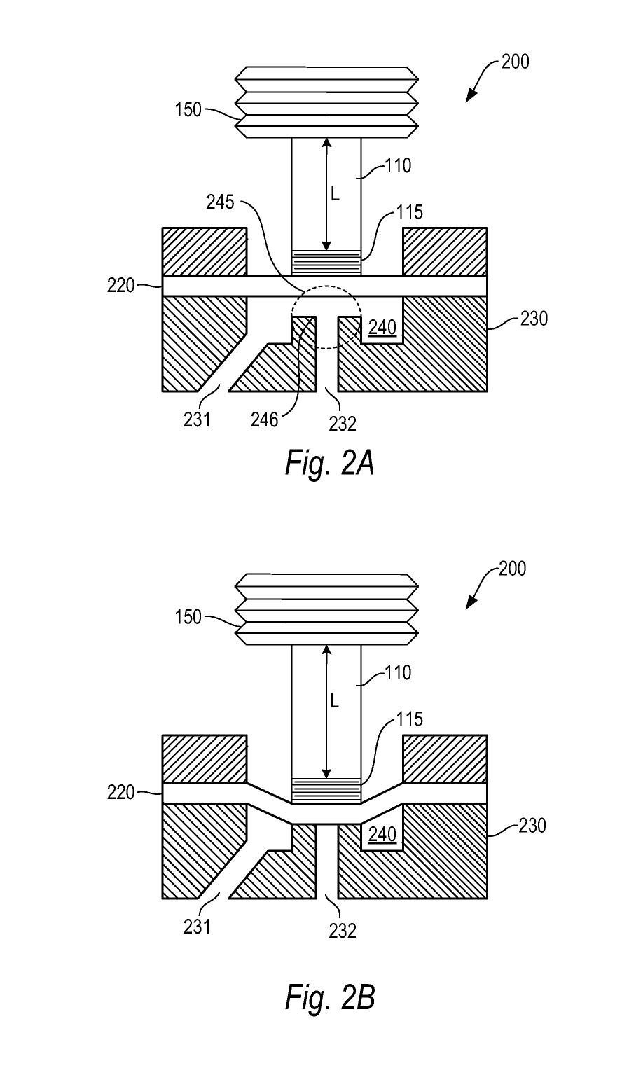

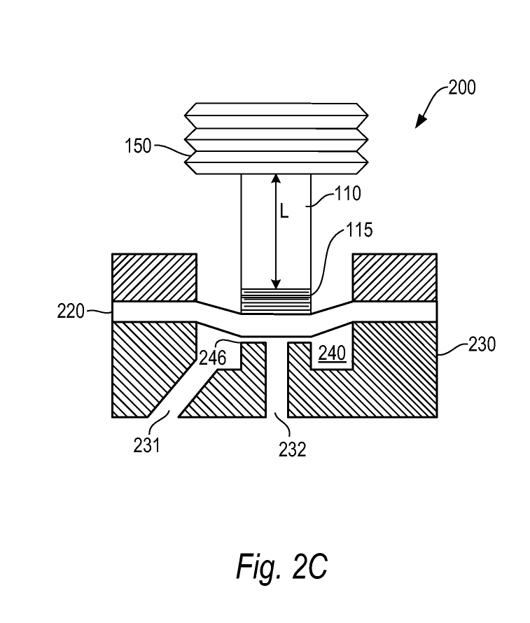

FIGS. 2A, 2B and 2C are cross-sectional diagrams illustrating a fluid transfer device including a piezoelectric actuator, according to a representative embodiment.

Referring to FIGS. 2A to 2C, fluid transfer device 200 includes piezoelectric actuator 110, boss 115 and high-stiffness actuator 150, which are assumed for purposes of explanation to be the same as discussed above with reference to FIGS. 1A and 1B. The fluid transfer device 200 further includes planar microfluidic valve device 230, which includes internal valve chamber 240, flexible membrane 220, inlet port 231 and outlet port 232. The microfluidic valve device 230 also includes valve 245, which is formed within the valve chamber 240 by operation of the flexible membrane 220 and protruding portion 246 of the outlet port 232. As discussed in detail below, the flexible membrane 220 is bent (or deformed) downward from its initial position (shown in FIG. 2A) to a flexed position (shown in FIG. 2B) to mechanically contact the protruding portion 246, preventing fluid from entering the inlet port 231 or exiting the outlet port 232, and thus effectively closing the valve 245. The flexible membrane 220 is then unbent upward from the flexed position to its initial position, enabling fluid to enter the inlet port 231 and to exit the outlet port 232, effectively opening the valve 245.

Each of the piezoelectric actuator 110, the boss 115 and the high-stiffness actuator 150 are external to the microfluidic valve device 230, as discussed above. For example, the piezoelectric actuator 110 is externally coupled in that it is arranged entirely outside the valve chamber 240, and therefore is not in contact with the fluid contained in or passing through the valve chamber 240 and/or the valve 245. The piezoelectric actuator 110, the boss 115 and the high-stiffness actuator 150 may be detachable from the microfluidic valve device 230, as well.

The microfluidic valve device 230 may be formed of a durable material, such as stainless steel or other metal. Alternatively, the microfluidic pump device 230 may be formed of another material, such as glass, ceramic, silicon or a polymer, such as polyimide, polycarbonate or other plastic, without departing from the scope of the present teachings. Likewise, the flexible membrane 220 may be formed of a flexible metal, such as stainless steel, for example. Alternatively, the flexible membrane 220 may be formed of another material, such as polymers, glass, ceramics, and metals or some combination thereof, without departing from the scope of the present teachings. As discussed above, in various embodiments, the internal surfaces of the microfluidic pump device 230 (e.g., walls of the valve chamber 240) are coated with a non-reactive coating, which may include a polymer, ceramic, glass, metal or fluoropolymer coating, for example.

As discussed above, the piezoelectric actuator 110 has an axial displacement along lengthwise axis L responsive to application of a bias voltage (not shown). For example, upon application of the bias voltage (e.g., 100V), the piezoelectric actuator 110 extends from a contracted position (shown in FIG. 2A) to an extended position (shown in FIG. 2B), forcing the flexible membrane 220 of the microfluidic valve device 230 to bend downward into the valve chamber 240 a distance corresponding to the axial displacement via the boss 115. As mentioned above, the flexible membrane 220 thus covers the protruding portion 246 of the outlet port 232, effectively closing the valve 245 (shown in FIG. 2B). Similarly, when application of the bias voltage is reduced (e.g., 0V is applied), the piezoelectric actuator 110 contracts from the extended position (shown in FIG. 2B) to its initial contracted position (shown in FIG. 2A), allowing the flexible membrane 220 of the microfluidic valve device 230 to move upward out of the valve chamber 240. The upward movement of the flexible membrane 220 thus expands the valve chamber 240, and uncovers the protruding portion 246, effectively opening the valve 245 (shown in FIG. 2A). Opening the valve 245 enables the valve chamber 240 to draw in fluid through the inlet port 231. The application of the bias voltage to the piezoelectric actuator 110 is repeated in a periodic fashion to cause the valve 245 to alternately open and close, enabling the fluid to be drawn in and expelled through the inlet port 231 and the outlet port 232, respectively, providing fluid pumping functionality.

The fluid transfer device 200 may also be configured to enable variable flow restriction (or variable flow modulation) of the fluid. Referring to FIG. 2C, for example, an interim bias voltage (e.g., 50V) may be applied to the piezoelectric actuator 110 to provide an axial displacement along lengthwise axis L between the fully contracted position (shown in FIG. 2A) and the fully extended position (shown in FIG. 2B). The interim bias voltage is between the bias voltage (e.g., 0V) for fully contracting piezoelectric actuator 110 and the bias voltage (e.g., 100V) for fully extending the piezoelectric actuator 110. The amount of extension of the piezoelectric actuator 110 may be a linear function or a non-linear function of the interim bias voltage, depending on the particular implementation.

Application of the interim bias voltage forces the flexible membrane 220 of the microfluidic valve device 230 to bend downward into the valve chamber 240 a distance corresponding to the axial displacement via the boss 115, e.g., about half the distance to the protruding portion 246 in the depicted example. By continuous application of the interim bias voltage, the flexible membrane 220 is held in this position above the protruding portion 246, creating a restriction, which adjusts flow of the fluid from the inlet port 231 to the outlet port 232 through the fluid transfer device 200. In other words, the interim bias voltage is applied to the piezoelectric actuator 110 continuously to maintain a constant axial displacement and to cause the fluid transfer device 200 to provide flow restriction functionality.

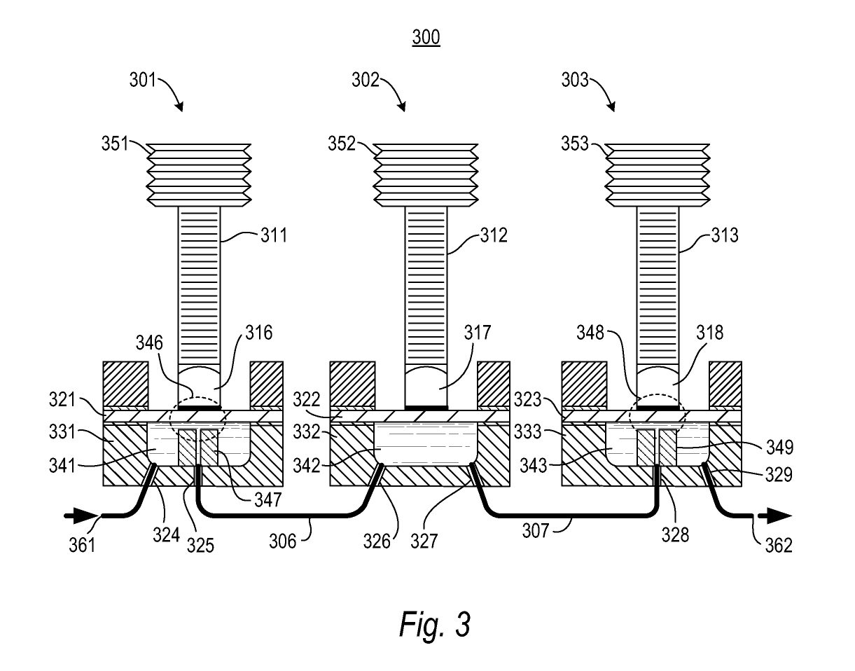

In the depicted embodiment, increasing the interim bias voltage further closes the restriction, thus decreasing the fluid flow, and decreasing the interim bias voltage further opens the restriction, thus increasing the fluid flow, to attain the desired flow rate. The fluid flow may be enabled by pumping action of other fluid transfer devices, such as the pumping action described above with reference to FIGS. 1A-2B, in fluid communication with the fluid transfer device 200 to which the interim bias voltage is applied. Examples of fluid transfer devices in fluid communication with one another are described below with reference to FIGS. 3-5B, 7 and 12A-12B.

In various embodiments, the fluid transfer device 100 may be similarly configured for flow modulation. For example, referring to FIG. 1B, upon application of the bias voltage (e.g., 100V), the piezoelectric actuator 110 extends to extended position, forcing the flexible membrane 120 to bend downward into the pump chamber 140. By maintaining application of the bias voltage, the flexible membrane 120 is held in this position, creating a restriction, which adjusts flow of the fluid from the inlet port 131 to the outlet port 132 through the fluid transfer device 100. Likewise, the flow may be modulated by applying an interim bias voltage (e.g., 50V) between the between the bias voltage (e.g., 0V) for fully contracting piezoelectric actuator 110 and the bias voltage (e.g., 100V) for fully extending the piezoelectric actuator 110. Continuous application of the interim bias voltage causes the piezoelectric actuator 110 to maintain a position between fully contracted and fully extended (not shown), depending on the desired flow rate.

FIG. 3 is a cross-sectional diagram illustrating a multiple valve fluid transfer device, according to a representative embodiment.

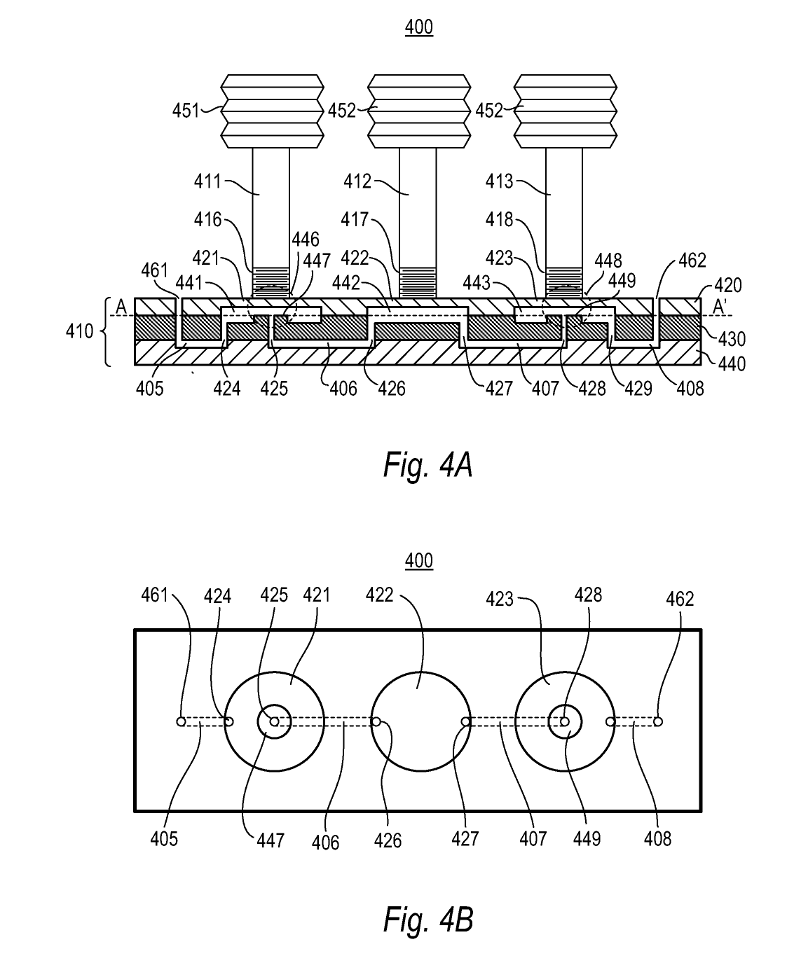

Referring to FIG. 3, fluid transfer device 300 includes inlet valve device 301, pump device 302 and outlet valve device 303, which are shown as separate microfluidic devices in fluid communication with one another though fluid conduits 306 and 307, respectively. In the depicted embodiment, the inlet valve device 301 may be substantially the same as the fluid transfer device 200 shown in FIGS. 2A-2C, and the pump device 302 may be substantially the same as the fluid transfer device 100 shown in FIGS. 1A and 1B. The outlet valve device 303 may be similar to the fluid transfer device 200 shown in FIGS. 2A-2C, except that the inlet port and the outlet port are reversed, as discussed below. In an alternative embodiment, the inlet valve device 301, the pump device 302 and the outlet valve device 303 may be manufactured as a single, integrated unit, an example of which is shown in FIGS. 4A and 4B.

The inlet valve device 301 includes a first piezoelectric actuator 311 mechanically coupled to flexible membrane 321 of microfluidic valve device 331 via boss 316 for operation of inlet valve 346 in inlet valve chamber 341. As discussed above, the first piezoelectric actuator 311 has a first axial displacement along its lengthwise axis responsive to selective application of a first bias voltage (not shown). That is, sequential application and reduction (e.g., removal) of the first bias voltage causes the piezoelectric actuator 311 to extend and contract accordingly, bending and unbending the flexible membrane 321 of the microfluidic valve device 331 to alternately close and open the inlet valve 346. When closed, the inlet valve 346 prevents fluid from being drawn in to the inlet port 324, which corresponds to the device inlet port 361 of the fluid transfer device 300, or expelled from the outlet port 325 by pressing the flexible membrane 321 against protruding portion 347. When opened, the inlet valve 346 enables fluid to be drawn in to the inlet port 324 and expelled from the outlet port 325.

The pump device 302 includes a second piezoelectric actuator 312 mechanically coupled to flexible membrane 322 of microfluidic pump device 332 via boss 317 for operation of pump chamber 342. As discussed above, the second piezoelectric actuator 312 has a second axial displacement along its lengthwise axis responsive to selective application of a second bias voltage (not shown). That is, sequential application and reduction (e.g., removal) of the second bias voltage causes the piezoelectric actuator 312 to extend and contract accordingly, bending and unbending the flexible membrane 322 of the microfluidic valve device 332 to alternately compress and expand the pump chamber 342. When being compressed, the pump chamber 342 expels fluid from the outlet port 327, e.g., while the inlet valve 346 (discussed above) is closed to prevent the fluid from being drawn in to the inlet port 326, and the outlet valve 348 (discussed below) is open to allow the fluid to be expelled from the outlet port 327. When being expanded, the pump chamber 342 draws fluid in through the inlet port 326, e.g., while the outlet valve 348 (discussed below) is closed, preventing the fluid being expelled through the outlet port 327, and the inlet valve 346 (discussed above) is open to allow the fluid to be drawn in through the inlet port 326.

The outlet valve device 303 includes a third piezoelectric actuator 313 mechanically coupled to flexible membrane 323 of microfluidic valve device 333 via boss 318 for operation of inlet valve 348 in inlet valve chamber 343. As discussed above, the third piezoelectric actuator 313 has a third axial displacement along its lengthwise axis responsive to selective application of a third bias voltage (not shown). That is, sequential application and reduction (e.g., removal) of the third bias voltage causes the piezoelectric actuator 313 to extend and contract accordingly, bending and unbending the flexible membrane 323 of the microfluidic valve device 333 to alternately close and open the outlet valve 348. When closed, the outlet valve 348 prevents fluid from being drawn in to the inlet port 328 or expelled from the outlet port 329, which corresponds to the device outlet port 362 of the fluid transfer device 300, by pressing the flexible membrane 323 against protruding portion 349. When opened, the outlet valve 348 enables fluid to be drawn in to the inlet port 328 and expelled from the outlet port 329.

The inlet valve device 301, the pump device 302 and the outlet valve device 303 include high-stiffness actuators 351, 352 and 353, respectively, which are coupled to the corresponding first, second and third piezoelectric actuators 311, 312 and 313. Each of the high-stiffness actuators 351, 352 and 353 may be a low compliance, slow speed actuator configured to adjust a position of the respective first, second and third piezoelectric actuators 311, 312 and 313, as discussed above with reference to the high-stiffness actuator 150 in FIGS. 1A-2C. In the depicted example, the high-stiffness actuators 351, 352 and 353 are implemented as adjustable screw-drives configured to adjust the position of the first, second and third piezoelectric actuators 311, 312 and 313 along the corresponding lengthwise axes by moving the screw-drive clockwise or counter-clockwise directions, accordingly.

The operations of the inlet valve device 301 and the outlet valve device 303 are coordinated with operation of the pump device 302 to enable movement of fluid from the device inlet port 361 to the device outlet port 362 through the fluid transfer device 300. For example, as discussed above, to expel fluid from the device outlet port 362, the first and second bias voltages are applied to the first and second piezoelectric actuators 311 and 312, respectively, causing the inlet valve 346 of the inlet valve device 301 to close and causing the pump chamber 342 of the pump device 302 to compress. At the same time, the third bias voltage is reduced to (e.g., 0V is applied) the third piezoelectric actuator 313 causing the outlet valve 348 of the outlet valve device 303 to open, enabling the fluid in the pump chamber 342 to exit through the device outlet port 362 via the outlet port 327. To draw fluid in to the device inlet port 361, the first and second bias voltages are reduced to (e.g., 0V is applied) the first and second piezoelectric actuators 311 and 312, respectively, causing the outlet valve 346 of the inlet valve device 301 to open and causing the pump chamber 342 of the pump device 302 to expand. At the same time, the third bias voltage is applied to the third piezoelectric actuator 313 causing the outlet valve 348 of the outlet valve device 303 to close, enabling the fluid to be drawn into the pump chamber 342 through the device inlet port 361 via the inlet port 326.

In alternative embodiments, one or more of the inlet valve device 301, the outlet valve device 303 and the pump device 302 act as a variable flow modulator, as discussed above. For example, one or more of the first through third bias voltages may be maintained as an interim bias voltage, causing the corresponding first through third piezoelectric actuator 311-313 to extent and hold the first through third flexible membrane 321-323 in a fixed position, respectively, restricting fluid flow by a desired amount. This also applies to the illustrative implementations discussed below with reference to FIGS. 4A-5B, 7 and 12A-12B.

In various embodiments, timing of the application and reduction (e.g., removal) of the first, second and third bias voltages may be controlled by a controller (not shown), such as a processor or central processing unit (CPU), application specific integrated circuits (ASICs), field-programmable gate arrays (FPGAs), or combinations thereof, using software, firmware, hard-wired logic circuits, or combinations thereof. For example, the controller may be configured to determine a rate at which to periodically apply the first through third bias voltages to the corresponding first through third piezoelectric actuators 311-313 to achieve the desired pumping rate, and to apply the determined rate accordingly. Likewise, the controller may be configured to determine an extension of one or more of the first through third piezoelectric actuators 311-313 corresponding to a desired flow rate, and to control application of the first through third bias voltages to move the corresponding first through third flexible membrane to the proper position for restricting the flow of the fluid to the desired flow rate.

When using a processor or CPU, a memory (not shown) is included for storing executable software/firmware and/or executable code that controls signals from the controller to the actuator the first, second and third actuators 311-313. The memory may be any number, type and combination of nonvolatile read only memory (ROM) and volatile random access memory (RAM), and may store various types of information, such as computer programs and software algorithms executable by the processor or CPU. The memory may include any number, type and combination of tangible computer readable storage media, such as a disk drive, an electrically programmable read-only memory (EPROM), an electrically erasable and programmable read only memory (EEPROM), a CD, a DVD, a universal serial bus (USB) drive, and the like. The first, second and third bias voltages may be from the same or different voltage sources, and/or may be the same or different from one another, depending on the characteristics of the corresponding one of the first, second and third actuators 311-313, as would be apparent to one of ordinary skill in the art.

In various embodiments, the displacement of each of the first, second and third piezoelectric actuators 311, 312 and 313 is limited to less than about 100 μm, and may be less than about 10 μm in various configurations. The fluid volume expelled from the device outlet port 362 at each pump stroke is therefore relatively small, typically on the order of about 20 nanoliters, for example. However, the first, second and third piezoelectric actuators 311, 312 and 313 are able to operate at relatively high frequencies, e.g., from about 10 cycles/second to about 10,000 cycles/second, allowing fluid flow to exceed about 10 μL/min.

FIGS. 4A and 4B are cross-sectional diagrams illustrating a multiple valve, integrated fluid transfer device, formed as a single unit, according to a representative embodiment. In particular, FIG. 4B shows the cross-section of FIG. 4A along line A-A′.

Referring to FIG. 4A, integrated fluid transfer device 400 includes inlet valve device 401, pump device 402 and outlet valve device 403, which share integrated, planar microfluidic device 410. That is, in the depicted embodiment, inlet valve chamber 441, pump chamber 442 and outlet valve chamber 443 are fabricated as separate regions in the single microfluidic device 410 device. The microfluidic device 410 includes three separate layers or plates, referred to as membrane plate 420, orifice plate 430 and connection plate 440, each of which may be patterned on one or both sides, for example, using electrochemical etching. The patterned membrane plate 420, orifice plate 430 and connection plate 440 are aligned and joined together to create the various features of the integrated fluid transfer device 400, including the device inlet port 461, the inlet valve chamber 441, the pump chamber 442, the outlet valve chamber 443 and the device outlet port 462, as well as inlet and outlet ports 424-429 and fluid conduits 405-408 that enable fluid communication among the device inlet port 461, the inlet valve chamber 441, the pump chamber 442, the outlet valve chamber 443 and the device outlet port 462.

The inlet valve chamber 441 and the outlet valve chamber 443 include corresponding inlet valve 446 and outlet valve 448, which function through bending and unbending first and third flexible regions 421 and 423 of the membrane plate 420 by operation of the first and third piezoelectric actuators 411 and 413, respectively. Likewise, the pump chamber 442 is function through bending and unbending second flexible region 422 of the membrane plate 420 by operation of the second piezoelectric actuator 412. The membrane plate 420, the orifice plate 430 and the connection plate 440 may be formed of metal or other flexible material, such as sheets of stainless steel, for example. When using metal, the membrane plate 420, the orifice plate 430 and the connection plate 440 may be aligned and fused together using high temperature metal diffusion bonding.

As shown in FIG. 4B, the first, second and third flexible regions 421, 422 and 423 may be circular in shape. Protruding portions 447 and 449 may likewise be circular in shape, and are centered within the first and third flexible regions 421 and 423, respectively. The first, second and third flexible regions 421, 422 and 423 may be the same size, having diameters from about 1.0 mm to 10 mm, for example, and more particularly, from about 4.0 mm to about 5.0 mm. In alternative configurations, the first, second and third flexible regions 421, 422 and 423 may be shapes other than circles, and/or may be different sizes from one another, without departing from the scope of the present teachings.

More particularly, the inlet valve device 401 includes the first piezoelectric actuator 411 mechanically coupled to the first flexible region 421 of the membrane plate 420 via boss 416 for operation of the inlet valve 446 in inlet valve chamber 441. As discussed above, the first piezoelectric actuator 411 has a first axial displacement along its lengthwise axis responsive to selective application of a first bias voltage (not shown), such that sequential application and reduction (e.g., removal) of the first bias voltage causes the piezoelectric actuator 411 to extend and contract accordingly, bending and unbending the first flexible region 421 to alternately close and open the inlet valve 446. When closed, the inlet valve 446 prevents fluid from being drawn in to the inlet port 424 (which is connected to the device inlet port 461 via the conduit 405) or expelled from the outlet port 425 by pressing the first flexible portion 421 against protruding portion 447. When opened, the inlet valve 446 enables fluid to be drawn in to the inlet port 424 and expelled from the outlet port 425.

The pump device 402 includes the second piezoelectric actuator 412 mechanically coupled to the second flexible region 422 of the membrane plate 420 via boss 417 for operation of the pump chamber 442. As discussed above, the second piezoelectric actuator 412 has a second axial displacement along its lengthwise axis responsive to selective application of a second bias voltage (not shown), such that sequential application and reduction (e.g., removal) of the second bias voltage causes the piezoelectric actuator 412 to extend and contract accordingly, bending and unbending the second flexible portion 422 to alternately compress and expand the pump chamber 442. When being compressed, the pump chamber 442 expels fluid from the outlet port 427, e.g., while the inlet valve 446 (discussed above) is closed to prevent the fluid from being drawn in to the inlet port 426, and the outlet valve 448 (discussed below) is open to allow the fluid to be expelled from the outlet port 427. When being expanded, the pump chamber 442 draws fluid in through the inlet port 426, e.g., while the outlet valve 448 (discussed below) is closed, preventing the fluid being expelled through the outlet port 427, and the inlet valve 446 (discussed above) is open to allow the fluid to be drawn in through the inlet port 426.

The outlet valve device 403 includes the third piezoelectric actuator 413 mechanically coupled to the third flexible portion 423 of the membrane plate 420 via boss 418 for operation of the inlet valve 448 in inlet valve chamber 443. As discussed above, the third piezoelectric actuator 413 has a third axial displacement along its lengthwise axis responsive to selective application of a third bias voltage (not shown), such that sequential application and reduction (e.g., removal) of the third bias voltage causes the piezoelectric actuator 413 to extend and contract accordingly, bending and unbending the third flexible portion 423 to alternately close and open the outlet valve 448. When closed, the outlet valve 448 prevents fluid from being drawn in to the inlet port 428 or expelled from the outlet port 429 (which is connected to the device outlet port 462 via the conduit 408) by pressing the third flexible portion 423 against protruding portion 449. When opened, the outlet valve 448 enables fluid to be drawn in to the inlet port 428 and expelled from the outlet port 429.

The inlet valve device 401, the pump device 402 and the outlet valve device 403 include high-stiffness actuators 451, 452 and 453, respectively, which are coupled to the corresponding first, second and third piezoelectric actuators 411, 412 and 413. Each of the high-stiffness actuators 451, 452 and 453 may be a low compliance, slow speed actuator configured to adjust a position of the respective first, second and third piezoelectric actuators 411, 412 and 413, as discussed above with reference to the high-stiffness actuator 150 in FIGS. 1A-2B. In the depicted example, the high-stiffness actuators 451, 452 and 453 are implemented as adjustable screw-drives configured to adjust the position of the first, second and third piezoelectric actuators 411, 412 and 413 along the corresponding lengthwise axes by moving the screw-drive clockwise or counter-clockwise directions, accordingly.

The operations of the inlet valve device 401 and the outlet valve device 403 are coordinated with operation of the pump device 402 by a controller (not shown) to enable movement of fluid from the device inlet port 461 to the device outlet port 462 through the fluid transfer device 400, substantially the same as discussed above with reference to the fluid transfer device 300 shown in FIG. 3. Therefore, the specific details regarding structure and/or operation of the controller (and associated memory) will not be repeated. A micropump configured as the fluid transfer device 400 may produce from about 50 bar to over about 1000 bar of pressure, for example.

Overall compliance of the fluid transfer device 400 is determined, in part, by the amount of fluid being transferred from the valve ports, e.g., the outlet port 425 of the inlet valve 446 and the inlet port 428 of the outlet valve 448. The inlet and outlet valves 446 and 448 also have fluidic connections, e.g., inlet port 424 and outlet port 429, that connect to the inlet and outlet valve chambers 441 and 443, respectively. In order to reduce the amount of entrained fluid, the pump chamber 442 is connected to both the outlet port 425 of the inlet valve 446 (via the conduit 406) and the inlet port 428 of the outlet valve 448 (via the conduit 407). In this way, the fluid contained in the inlet and outlet valve chambers 441 and 443 does not play a role in determining the overall compliance of the fluid transfer device 400. In an illustrative configuration, the depth of the pump chamber 442 may on the order of about 10 μm to about 100 μm, for example, to reduce the corresponding chamber volume. For applications in which compliance of the fluid transfer device 400 is not as critical, the depth of the pump chamber 442 may be larger and/or the pump chamber 442 may be connected to the device inlet port 461 or the device outlet port 462 outside of the respective outlet port 425 and inlet port 428.

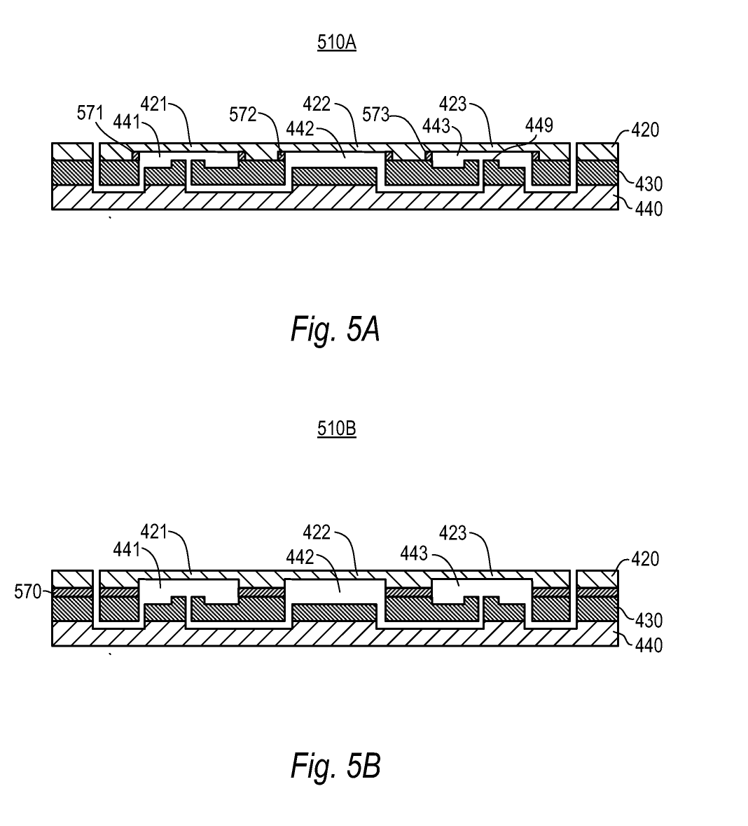

FIGS. 5A and 5B are cross-sectional diagrams illustrating multiple valve planar microfluidic devices of integrated fluid transfer assemblies, according to representative embodiments. More particularly, FIG. 5A shows a cross-section of planar microfluidic device 510A and FIG. 5B shows a cross-section of planar microfluidic device 510B, each of which includes a membrane plate 420 that is detachable via a seal layer, as discussed below.

Referring to FIG. 5A, the planar microfluidic device 510A includes membrane plate 420, orifice plate 430 and connection plate 440, which are patterned, aligned and joined together to create the various features of an integrated fluid transfer device, as discussed above with reference to the fluid transfer device 400 and corresponding planar microfluidic device 410 in FIGS. 4A and 4B. In addition, a bottom surface of the membrane plate 420 is detachably connected to a top surface of the orifice plate 430 by a sealing layer that includes series of o-rings, including first o-ring 571, second o-ring 572 and third o-ring 573. The first o-ring 571 surrounds the first flexible region 421 to seal the perimeter of the inlet valve chamber 441, the second o-ring 572 surrounds the second flexible region 422 to seal the perimeter of the pump chamber 442, and the third o-ring 573 surrounds the third flexible region 423 to seal the perimeter of the outlet valve chamber 443. Each of the first, second and third o-rings 571-573 may be formed of a compliant polymer, such as Viton®, PTFE, Kalrez®, for example. Thus, the respective seals are formed by compressing the membrane plate 420 against the first, second and third o-rings 571-573, enabling the membrane plate 420 to be well-sealed to the orifice plate 430. Otherwise, the formation and operation of the planar microfluidic device 510A is substantially the same as discussed above with reference to the planar microfluidic device 410.

Similarly, referring to FIG. 5B, the planar microfluidic device 510B includes the membrane plate 420, the orifice plate 430 and the connection plate 440, which are patterned, aligned and joined together to create the various features of an integrated fluid transfer device, as discussed above with reference to the fluid transfer device 400 and corresponding planar microfluidic device 410 of FIGS. 4A and 4B. In addition, a bottom surface of the membrane plate 420 is detachably connected to a top surface of the orifice plate 430 by a sealing layer that includes a sealing membrane 570, which may be formed of a polymer, such as polyimide, PEEK, PAEK, or Vespel®, for example. Thus, the seals surrounding the inlet valve chamber 441, the pump chamber 442 and the outlet valve chamber 443 are formed by compressing the membrane plate 420 against the sealing membrane 570, enabling the membrane plate 420 to be well-sealed to the orifice plate 430. Otherwise, the formation and operation of the planar microfluidic device 510B is substantially the same as discussed above with reference to the planar microfluidic device 410.

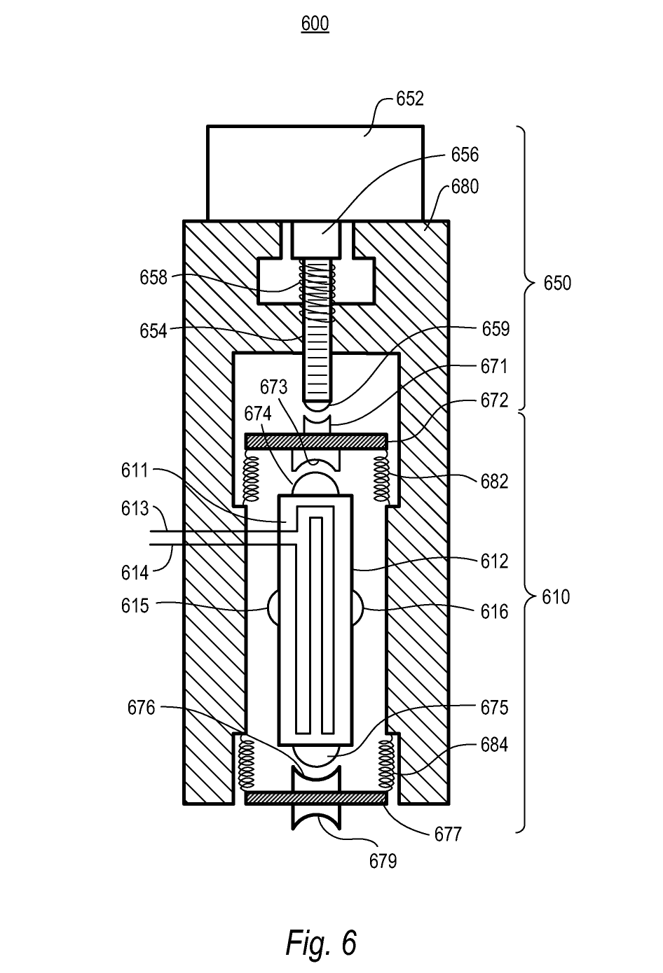

FIG. 6 is a cross-sectional diagram illustrating an actuating device, according to a representative embodiment. For example, the actuating device includes a piezoelectric actuator and a high-stiffness actuator for driving a planar microfluidic device, where the piezoelectric actuator and the high-stiffness actuator shown in FIG. 6 may be detailed configurations of the piezoelectric actuator 110 and the high-stiffness actuator 150 discussed above with reference to FIGS. 1-2, the first, second and third piezoelectric actuators 311-313 and the first, second and third high-stiffness actuators 351-353 discussed above with reference to FIG. 3, and/or the first, second and third piezoelectric actuators 411-413 and the first, second and third high-stiffness actuators 451-453 discussed above with reference to FIGS. 4A and 4B.

Referring to FIG. 6, actuating device 600 includes illustrative high-stiffness actuator assembly 650 and illustrative piezoelectric actuator assembly 610. In the depicted embodiment, the high-stiffness actuator assembly 650 is a screw-drive, for example, including a rotary motor 652 attached to frame 680 and coupled to a fine pitch (e.g., M3, 0.2 mm pitch) adjustment screw 654 through a strain relief 656. The strain relief 656 accommodates misalignment of the rotary motor 652 and the adjustment screw 654, for example. The adjustment screw 654 is threaded through the frame 680, and may be pre-loaded against the threads with a screw preload 658, shown schematically as a spring. A first ball bearing surface 659 is machined or bonded to a distal end of the adjustment screw 654. When the adjustment screw 654 is extended, the first ball bearing surface 659 sits in a first mating socket 671 of the piezoelectric actuator assembly 610, and thus transmits displacement of the adjustment screw 654 to the piezoelectric assembly 610.

The first mating socket 671 is attached to a first support plate 672 that is free to move in a longitudinal (vertical) direction relative to the frame 680. However, the first support plate 672 is constrained laterally, so that it is not able to rotate, e.g., around a lengthwise axis of piezoelectric actuator 611, discussed below. Accordingly, when the adjustment screw 654 rotates, in a clockwise or counter-clockwise direction, the associated torque is accommodated by the first support plate 672 and is not coupled into the piezoelectric actuator 611. For example, the piezoelectric actuator 611 may be formed of sintered material(s), and would thus be susceptible to fracture if placed in torsion or tension by operation of the adjustment screw 654. The first support plate 672 is connected to the frame 680 by first spring support 682, shown schematically as two springs on either side of the first support plate 672. The first spring support 682 pulls the first support plate 672 and attached second mating socket 673 into contact with second ball bearing surface 674 attached to one end of the piezoelectric actuator 611.

The piezoelectric actuator 611 is effectively the core of the actuating device 600. The piezoelectric actuator 611 may be any of a variety of piezoactuators, either housed or bare, formed from any of a variety of piezoelectric materials. For example, the piezoelectric actuator 611 may be a stacked piezoelectric actuator, such as Piezoelectric Actuator AE0505D16F available from Thorlabs, or a piezoelectric tube, such as Piezo Tube Actuator PT-120 available from Physik Instrumente, although other types of piezoelectric actuators may be incorporated without departing from the scope of the present teachings. In FIG. 6, the piezoelectric actuator 611 is shown with strain gauge 612. The resistance of the strain gauge 612 changes when the piezoelectric actuator 611 extends upon application of a voltage across first and second voltage leads 615 and 616, or contracts upon reduction of the voltage from the first and second voltage leads 615 and 616. The strain gauge 612 is shown schematically, where a constant current may be applied through first strain gauge lead 613, and the strain gauge resistance may be monitored by measuring the voltage induced between the first strain gauge lead 613 and second strain gauge lead 614. In an embodiment, the strain gauge 612 may be arranged in a resistor bridge with two active sensors and two dummy resistors, for example.

Since very little torque should be applied to the piezoelectric actuator 611, mechanical contact is made with the piezoelectric actuator 611 through the second ball bearing surface 674 attached to one end of the piezoelectric actuator 611, discussed above, and a third ball bearing surface 675 attached to the opposite end of the piezoelectric actuator 611. The third ball bearing surface 675 contacts third mating socket 676, which is attached to second support plate 677. The second support plate 677 may be connected to the frame 680 by a second spring support 684, shown schematically as two springs on either side of the second support plate 677. Thus, when the adjustment screw 654 is retracted, the first spring support 682 and the second spring support 684 allow the piezoelectric actuator 611 to move freely in the longitudinal (vertical) direction, which is particularly significant when a corresponding microfluidic device (not shown in FIG. 6) is either removed or inserted. Examples of the corresponding microfluidic device include microfluidic pump devices 130 and 333 shown in FIGS. 1A, 1B and 3; microfluidic valve devices 230, 331 and 333 shown in FIGS. 2A, 2B, 2C and 3; and integrated microfluidic devices 410, 510A and 510B shown in FIGS. 4A, 4B, 5A and 5B, discussed above. The positions of the first spring support 682 and/or the second spring support 684 may be chosen so that a fourth mating socket 679 is pressed lightly (e.g., several Newtons of force) against a membrane or a bearing support mounted on the membrane of the corresponding microfluidic device attached to the piezoelectric actuator assembly 610.

The strain gauge 612 may serve two purposes, for example. First, the strain gauge 612 monitors the extension of the piezoelectric actuator 610 and allows the piezoelectric actuator 610 to move accurately. This is helpful in that the piezoelectric actuator 610, particularly when implemented as stack piezoelectric actuator 610, may show substantial creep and hysteresis with applied voltage. For this reason, in order to precisely meter the fluid expelled by the corresponding microfluidic device, it is necessary to gauge the physical displacement of the piezoelectric actuator 610 and to place a control loop around the voltage applied to the piezoelectric actuator 610. When a bias voltage on the order of about 100V, for example, is applied across the first and second voltage leads 615 and 616, the piezoelectric actuator 610 will extend several microns. For example, when the piezoelectric actuator 610 is implemented by a piezoelectric actuator AE0505D16F, mentioned above, application of about 100V causes the piezoelectric actuator 610 to extend approximately 12 μm. While a substantial portion of this 12 μm displacement will occur instantaneously with the applied voltage, there will be several microns of additional displacement that occurs over the course of minutes as the piezoelectric actuator 610 continues to “creep.”

Second, the strain gauge 612 provides feedback to the rotary motor 652, e.g., through a controller (not shown), for positioning the adjustment screw 654. For example, when the corresponding microfluidic device is inserted beneath the piezoelectric actuator 610, a small additional force is applied to the piezoelectric actuator 610, which is detectable as a small compression of the piezoelectric actuator 610. The first ball bearing surface 659 attached to the adjustment screw 654 is not in contact with the first mating socket 671 at this stage. When it is desired to actuate the corresponding microfluidic device, the rotary motor 652 is advanced and a resistance signal of the strain gauge 612 is monitored. Until the first ball bearing surface 659 contacts the first mating socket 671, there will be no change in resistance. However, when contact is made, the adjustment screw 654 will compress the piezoelectric actuator 611, pushing down on the membrane of the corresponding microfluidic device. The compression of the piezoelectric actuator 611 is detected by the strain gauge 612 as a decrease in resistance. Thus, a resistance set-point of the strain gauge 612 may be used to determine the appropriate pre-load from the adjustment screw 654.

In monitoring the compression of the piezoelectric actuator 611 at zero applied bias, the strain gauge 612 may also be used to monitor thermal drift that may occur. Since the piezoelectric actuator 611 may be several centimeters long, a temperature change of several degrees may cause the distal end of the piezoelectric actuator 611 to shift several microns, similar in magnitude to the displacement of the piezoelectric actuator 611. The motor 652 may compensate for this thermal drift by ensuring that the signal of the strain gauge 612 at zero applied bias remains constant. In various embodiments, operation and/or monitoring of the rotary motor 652, the strain gauge 612 and a voltage source (not shown) connected to the first and second voltage leads 615 and 616 may be performed by the controller (not shown). The controller may include a processor or CPU, ASICs, FPGAs, or combinations thereof, using software, firmware, hard-wired logic circuits, or combinations thereof, which may be similar to or the same as the controller discussed above with reference FIG. 3.

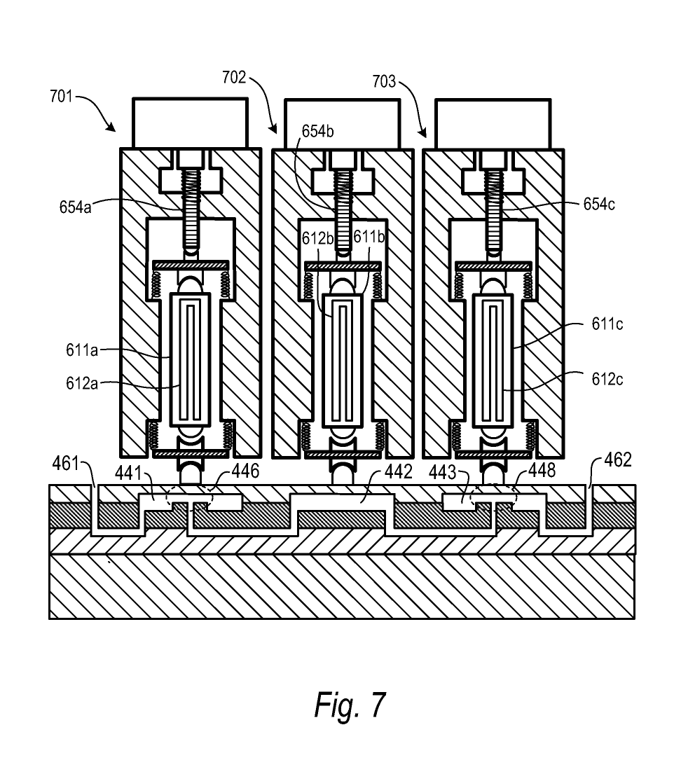

FIG. 7 is a cross-sectional diagram illustrating a multiple valve fluid transfer device, incorporating the actuating device of FIG. 6, according to a representative embodiment.

Referring to FIG. 7, multiple valve, integrated fluid transfer device 700 includes three actuator devices, first actuator device 701, second actuator device 702 and third actuator device 703, coupled to a corresponding microfluidic device 410. It is understood that each of the first, second and third actuator devices 701, 702 and 703 is substantially the same as the piezoelectric actuator 600, discussed above with reference to FIG. 6, and therefore the description will not be repeated. Likewise, the microfluidic device 410 is discussed above with reference to FIGS. 4A and 4B, and thus the description will not be repeated.

In the depicted embodiment, the microfluidic device 410 is inserted or attached to the external first, second and third actuator devices 701, 702 and 703. After fluidic connection is made to the device inlet port 461 and the device outlet port 462, the adjustable screws 654a, 654b and 654c of the first, second and third actuator devices 701, 702 and 703 corresponding to the inlet valve chamber 441, the pump chamber 442 and the outlet valve chamber 443 are extended until the respective strain gauges 612a, 612b and 612c reach their respective set points.

The integrated fluid transfer device 700 is primed by flowing fluid at low pressure through the inlet valve chamber 441, the pump chamber 442 and the outlet valve chamber 443. The piezoelectric actuator 611a corresponding to the inlet valve 446 is extended by applying 100V to close the inlet valve 446. The piezoelectric actuator 611b corresponding to the pump chamber 442 is extended by applying a continuously variable voltage less than 100V to compress the pump chamber 442. The extension of the piezoelectric actuators 611a and 611 may be monitored using the corresponding strain gauges 612a and 612, and the applied voltage may be controlled to provide a continuous flow of fluid.

When the piezoelectric actuator 611b corresponding to the pump chamber 442 reaches its full extension, the piezoelectric actuator 611c corresponding to the outlet valve 448 is extended by applying 100V to close the outlet valve 448, and the piezoelectric actuator 611a corresponding to the inlet valve 446 is contracted by applying 0V to previously open inlet valve 446. Meanwhile, the piezoelectric actuator 611b corresponding to the pump chamber 442 is contracted by applying 0V, which allows the pump chamber 442 to expand. The pumping operation then continues by repeating the alternate application of 100V and 0V to the piezoelectric actuators 611a-611c. That is, the piezoelectric actuator 611a corresponding to the inlet valve 426 is again extended by applying 100V to close the inlet valve 426, while the piezoelectric actuator 611c corresponding to the outlet valve 428 is again contracted by applying 0V to open the outlet valve 428.

In the present example, the piezoelectric actuator 611b corresponding to the pump chamber 442 will extend approximately 6 μm at each pump cycle, which causes approximately 20 nL to be expelled from the device outlet port 462. It is relatively straightforward to control the piezoelectric actuators 611a-611c to 1/1000 of its travel with using corresponding strain gauges 612a-612c, thus it is possible to control the fluid flow with 20 picoliters/min. accuracy in the present example. Moreover, the piezoelectric actuators 611a-611c are able to operate at high frequencies, and reliable operation is possible up to 100 Hz, corresponding to a flow rate of 120 μL/min.

In various configurations, the displacement of the piezoelectric actuator 611b may be relatively small relative to the depth of the pump chamber 442. It is important in such a configuration that the integrated fluid transfer device 700 be properly primed, or trapped air bubbles may otherwise degrade performance. Fluids used with HPLC instruments, for example, are usually degassed before entering the integrated fluid transfer device 700, which simplifies priming because small air bubbles will tend to diffuse back into the fluid. However, air bubbles in the fluid should still be minimized. An illustrative method for priming a pump chamber and valves, such as the pump chamber 442, the inlet valve 446, and the outlet valve 448 of the microfluidic device 410, in order to mitigate the formation of air bubbles in the fluid, is described below.

The device outlet port 462 should first be positioned above the device inlet port 461. For example, the microfluidic device 410 may be rotated (e.g., up to about 90 degrees), so that the device outlet port 462 is substantially disposed above the device inlet port 461. An organic fluid, such as methanol, may be used for priming, and then replaced with the desired working fluid, such as water, acetonitrile and methanol, for example. The entire microfluidic device 410 may be pumped out before priming, and then backfilled with carbon dioxide (CO₂), which dissolves more readily in most fluids. Also, the interior surfaces of the inlet and outlet valve chambers 441 and 443 and the pump chamber 442 may be coated with a hydrophilic or hydrophobic polymer to promote priming. The hydrophilic or hydrophobic polymer may be patterned to ensure that no bubbles are trapped as the fluid enters the inlet valve chamber 441, the pump chamber 442 and/or the outlet valve chamber 443.

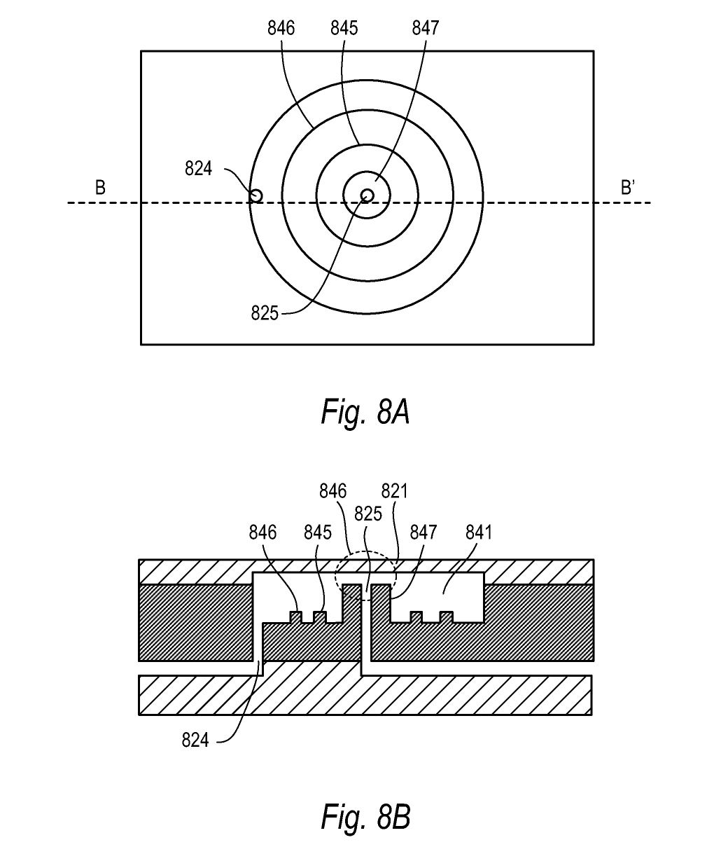

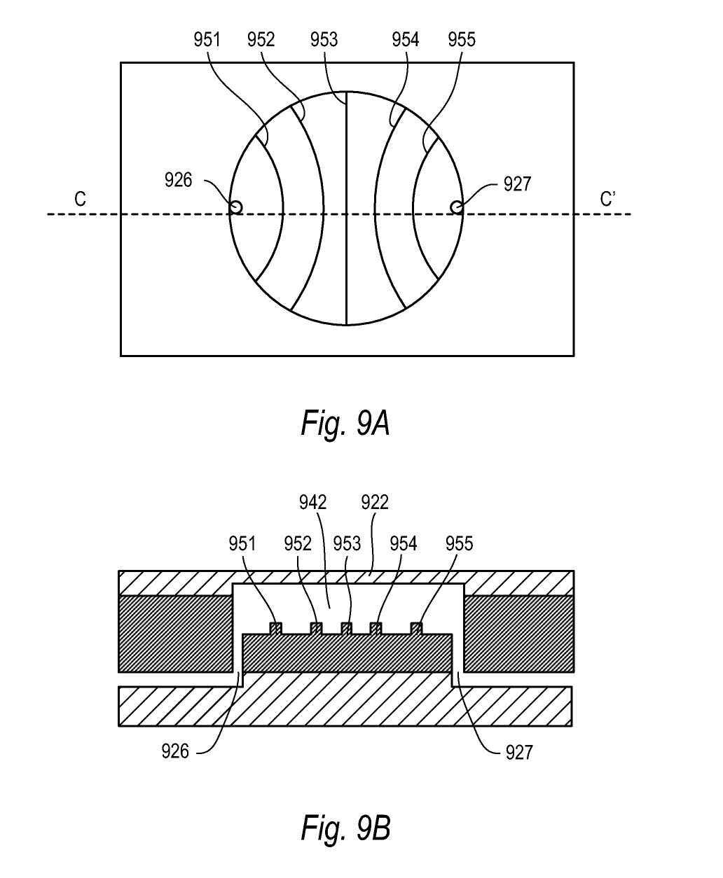

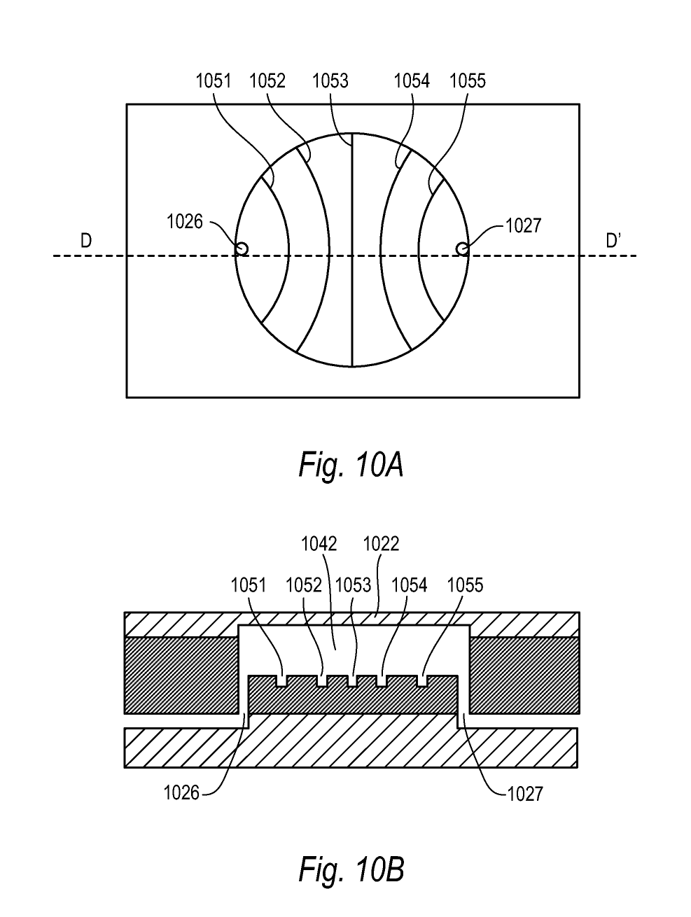

In addition, mechanical features may be incorporated into one or more of the inlet and outlet valve chambers 441 and 443 and/or the pump chamber 442, such as illustrative raised patterns (which may include multiple ribs, for example) shown in FIGS. 8A-9B and illustrative depressed patterns (which may include multiple grooves, for example) shown in FIGS. 10A-10B. The raised patterns arrest the growth of fluid droplets as the fluid enters the inlet and outlet valve chambers 441 and 443 and/or the pump chamber 442. The fluid does not pass into the next section until the area between each raised portion or rib of the raised pattern and a corresponding inlet (or previous raised portion) is completely filled with fluid. In this manner, inlet and outlet valve chambers 441 and 443 and/or the pump chamber 442 may be filled with very little trapped air.

FIGS. 8A and 8B are cross-sectional diagrams illustrating a valve chamber having a raised pattern, according to a representative embodiment. In particular, FIG. 8B shows the cross-section of FIG. 8A along line B-B′. Referring to FIGS. 8A and 8B, representative inlet valve chamber 841 includes inlet valve 846, which is formed by bending and unbending of flexible membrane 821 onto protruding portion 847 in response to operation of a piezoelectric actuator (not shown), as discussed above. Fluid enters the inlet valve chamber 841 through inlet port 824, and exits the inlet valve chamber 841 through outlet port 825. The inlet valve chamber 841 further includes a raised pattern having first and second ribs or raised portions 845 and 846, which are raised concentric circles surrounding the protruding portion 847. Of course, more or fewer raised portions may be included without departing from the scope of the present teachings.

FIGS. 9A and 9B are cross-sectional diagrams illustrating a pump chamber having a raised pattern, according to a representative embodiment. In particular, FIG. 9B shows the cross-section of FIG. 9A along line C-C′. Referring to FIGS. 9A and 9B, representative pump chamber 942 is formed by bending and unbending of flexible membrane 922 in response to operation of a piezoelectric actuator (not shown), as discussed above. Fluid enters the pump chamber 942 through inlet port 925, and exits the pump chamber 942 through outlet port 927. The pump chamber 942 further includes a raised pattern having first through fifth raised portions 951-955. In the depicted example, the third raised portion 953 traverses the inner diameter of the pump chamber 942, while the first and second raised portions 951 and 952 arc away from the third raised portion 953 to the left and the fourth and fifth raised portions 954 and 955 arc away from the third raised portion 953 to the right. Of course, more or fewer raised portions may be included without departing from the scope of the present teachings.

FIGS. 10A and 10B are cross-sectional diagrams illustrating a pump chamber having a depressed pattern, according to a representative embodiment. In particular, FIG. 10B shows the cross-section of FIG. 10A along line D-D′. Referring to FIGS. 10A and 10B, representative pump chamber 1042 is formed by bending and unbending of flexible membrane 1022 in response to operation of a piezoelectric actuator (not shown), as discussed above. Fluid enters the pump chamber 1042 through inlet port 1026, and exits the pump chamber 1042 through outlet port 1027. The pump chamber 1042 further includes an etched depressed pattern having first through fifth grooves or depressed portions 1051-1055. In the depicted example, the third depressed portion 1053 traverses the inner diameter of the pump chamber 1042, while the first and second depressed portions 1051 and 1052 arc away from the third depressed portion 1053 to the left and the fourth and fifth depressed portions 1054 and 1055 arc away from the third depressed portion 1053 to the right. Of course, more or fewer depressed portions may be included without departing from the scope of the present teachings.

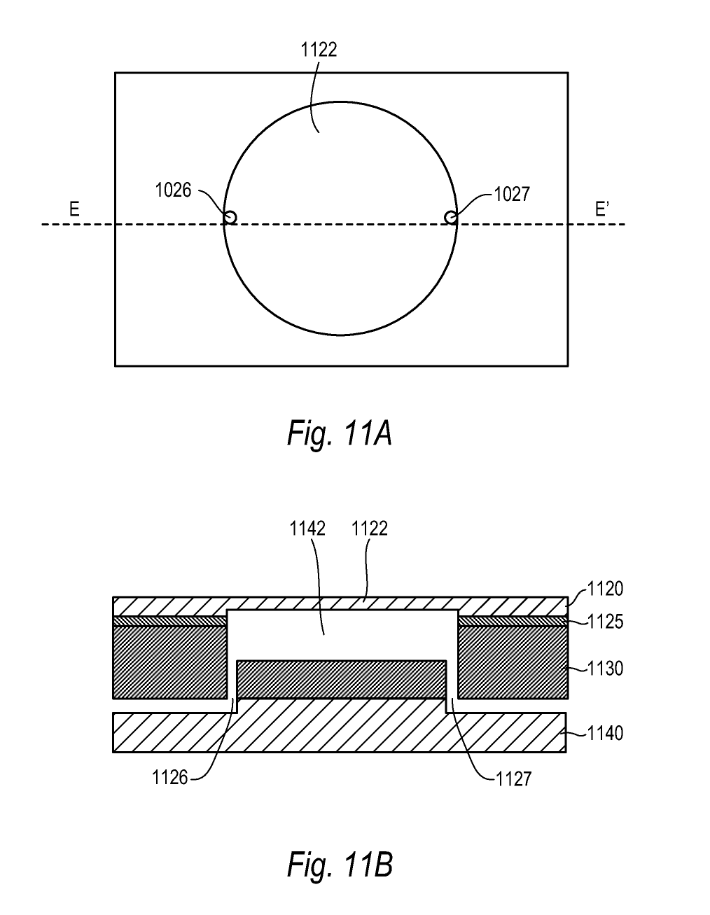

In another embodiment, the pump chamber and/or valve chamber may incorporate a gas permeable membrane. For example, FIGS. 11A and 11B are cross-sectional diagrams illustrating a pump chamber having a gas permeable membrane, according to a representative embodiment. In particular, FIG. 11B shows the cross-section of FIG. 11A along line E-E′. Referring to FIGS. 11A and 11B, representative pump chamber 1142 is formed by bending and unbending of flexible membrane 1122 in response to operation of a piezoelectric actuator (not shown), as discussed above. Fluid enters the pump chamber 1142 through inlet port 1126, and exits the pump chamber 1142 through outlet port 1127. The stacked membrane plate 1120, orifice plate 1130 and connection plate 1140 are patterned on one or both sides to form the pump chamber 1142, the inlet port 1126 and the outlet port 1127, as shown. In addition, gas permeable membrane 1125 is formed between the membrane plate 1120 and the orifice plate 1130, enabling trapped air bubbles (and other gases) to exit the pump chamber 1142, while retaining the fluid. The gas permeable membrane 1125 may be formed of various membrane materials, such as Nafion®, silicone rubber, agarose, or porous Teflon®, for example, although other materials may be incorporated without departing from the scope of the present teachings. The material used depends, at least in part, on the fluid being pumped and the internal pressure of the pump chamber 1142.

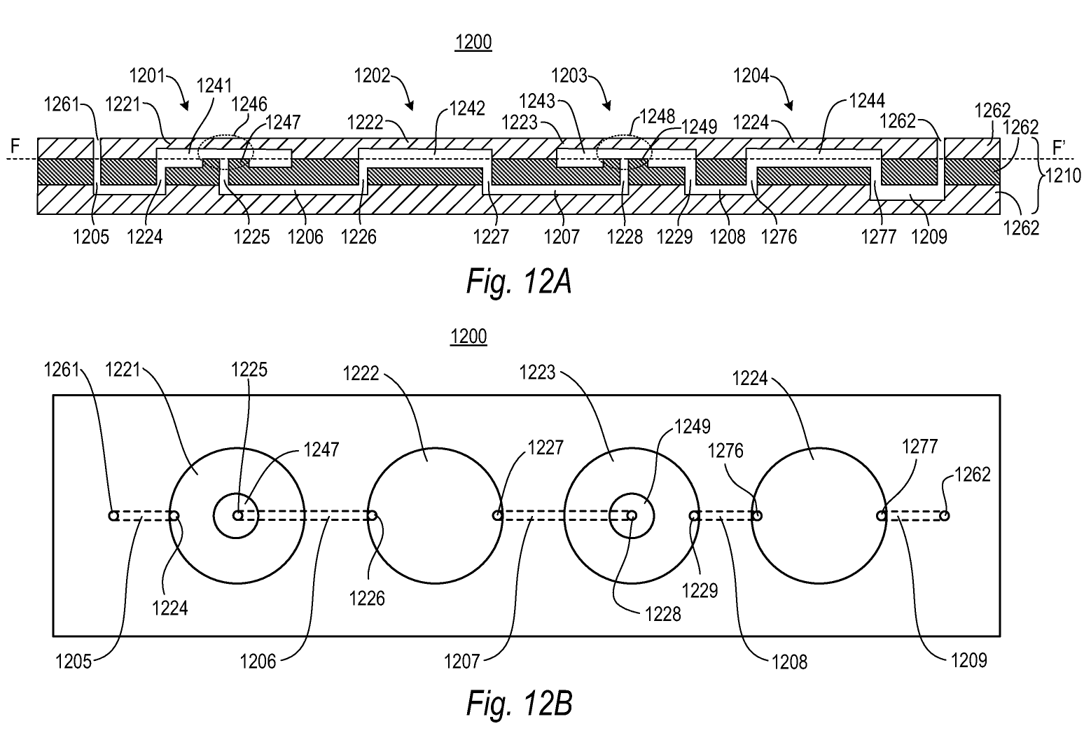

For certain implementations, such as in HPLC instruments, the fluid transfer device should have a continuous flow. The fluid transfer devices 300, 400 and 700 respectively described with reference to FIGS. 3, 4A, 4B and 7, for example, may not provide continuous flow because the external fluid flow stops when the corresponding pump chamber 342, 442 is being refilled. In contrast, FIGS. 12A and 12B are cross-sectional diagrams illustrating a multiple valve, integrated fluid transfer device having continuous flow, according to a representative embodiment. In particular, FIG. 12B shows the cross-section of FIG. 12A along line F-F′.

Referring to FIG. 12A, integrated fluid transfer device 1200 includes inlet valve device 1201, first pump device 1202, outlet valve device 1203 and second pump device 1204, which share integrated, planar microfluidic device 1210. That is, in the depicted embodiment, inlet valve chamber 1241, first pump chamber 1242, outlet valve chamber 1243, and second pump chamber 1244 are fabricated as separate regions in the single microfluidic device 1210 device. The integrated fluid transfer device 1200 as shown in FIGS. 12A and 12B may be referred to as a binary pump, for example.

As discussed above with reference to FIGS. 4A and 4B, the microfluidic device 1210 includes three separate layers or plates, referred to as membrane plate 1220, orifice plate 1230 and connection plate 1240, each of which may be patterned on one or both sides, for example, using electrochemical etching, in order to create the various features of the integrated fluid transfer device 1200 when they are aligned and joined together. These features include device inlet port 1261, the inlet valve chamber 1241, the first pump chamber 1242, the outlet valve chamber 1243, the second pump chamber 1244 and device outlet port 1262, as well as inlet and outlet ports 1224-1229 and 1276-1277 and fluid conduits 1205-1209 that enable fluid communication among the device inlet port 1261, the inlet valve chamber 1241, the first pump chamber 1242, the outlet valve chamber 443, the second pump chamber 1244 and the device outlet port 1262.

It is understood that each of the inlet valve device 1201, the first pump device 1202, the outlet valve device 1203 and the second pump device 1204 further includes a corresponding external piezoelectric actuator having axial displacement along its lengthwise axis, such as the first piezoelectric actuator 411 discussed above with reference to FIG. 4A (as well as a corresponding high-stiffness actuator and/or boss). However, the piezoelectric actuators are not shown in FIG. 12A for clarity and in order to simplify explanation. The structure and functionality of the piezoelectric actuators are substantially the same as discussed above.

The inlet valve chamber 1241 and the outlet valve chamber 1243 include corresponding inlet valve 1246 and outlet valve 1248, which function through bending and unbending first and third flexible regions 1221 and 1223 of the membrane plate 1220 by operation of corresponding piezoelectric actuators (not shown). Likewise, the first pump chamber 1242 and the second pump chamber 1244 function through bending and unbending second and fourth flexible regions 1222 and 1224 of the membrane plate 1220 by operation of corresponding piezoelectric actuators (not shown). As shown in FIG. 12B, the first through fourth flexible regions 1221-1224 may be circular in shape, for example. Protruding portions 1247 and 1249 may likewise be circular in shape, and are centered within the first and third flexible regions 1221 and 1223, respectively. The first through fourth flexible regions 1221-1224 may be the same or different in size and/or shape, as discussed above. Otherwise, the structure and operation of the inlet valve 1246 and the outlet valve 1248 are substantially same as that of the inlet valve 446 and the outlet valve 448, and the structure and operation of the first pump chamber 1242 and the second pump chamber 1244 are substantially same as that of the pump chamber 442, as discussed above with reference to FIGS. 4A and 4B. Therefore the descriptions will not be repeated herein.

The operations of the inlet valve device 1201 and the outlet valve device 1203 are coordinated with the operations of the first pump device 1202 and the second pump device 1204 by a controller (not shown) to enable movement of fluid from the device inlet port 1261 to the device outlet port 1262 through the fluid transfer device 1200, substantially the same as discussed above with reference to the fluid transfer device 300 shown in FIG. 3.

An illustrative operation of the integrated fluid transfer device 1200, providing a continuous flow of fluid, is described below. In the depicted embodiment, the microfluidic device 1210 is inserted or attached to the corresponding external piezoelectric actuators (not shown). After fluidic connection is made to the device inlet port 1261 and the device outlet port 1262, the adjustable screws or other external high-stiffness actuator (not shown) corresponding to the inlet valve chamber 1241, the first pump chamber 1242, the outlet valve chamber 1243 and the second pump chamber 1244 are extended until their respective strain gauges reach their respective set points, as discussed above. The integrated fluid transfer device 1200 is primed by flowing fluid at low pressure through the inlet valve chamber 1241, the first pump chamber 1242, the outlet valve chamber 1243 and the second pump chamber 1244. Initially, a piezoelectric actuator corresponding to the outlet valve device 1203 is extended by applying 100V to close the outlet valve 1248.

In a first action, a piezoelectric actuator corresponding to the inlet valve device 1201 is contracted by applying 0V to open the inlet valve 1246, and then a piezoelectric actuator corresponding to the first pump device 1202 is likewise contracted to fill the first pump chamber 1242 with fluid. The piezoelectric actuator corresponding to the inlet valve device 1201 is then expanded by applying 100V to close the inlet valve 1246, and the chamber piezoelectric actuator corresponding to the first pump device 1202 is slightly extended to approximately equalize the pressure in the first pump chamber 1242 with the pressure at the second pump chamber 1244. This state is maintained until completion of a second action, described in the subsequent paragraph, which is to be performed substantially simultaneously with the first action.

In the second action, a piezoelectric actuator corresponding to the second pump device 1204 is extended by applying a continuously variable voltage less than 100V to compress the second pump chamber 1244. The extension of the piezoelectric actuator is monitored, e.g., using a strain gauge, and the applied voltage is controlled to provide the continuous flow of fluid. When the piezoelectric reaches its full extension, the piezoelectric actuator corresponding to the outlet valve device 1203 is contracted by applying 0V to open the outlet valve 1248.

In a third action, a piezoelectric actuator corresponding to the first pump device 1202 is extended by applying a continuously variable voltage less than 100V to compress the first pump chamber 1241. The extension of the piezoelectric actuator is monitored, e.g., using a strain gauge, and the applied voltage is controlled to provide a continuous flow of fluid greater than the desired flow. When the piezoelectric actuator of the first pump device 1202 reaches its full extension, the process is repeated, e.g., by again beginning with extending the piezoelectric actuator corresponding to the outlet valve device 1203 by applying 100V to close the outlet valve 1248, and then performing the first through fourth actions, where the fourth action is to be performed substantially simultaneously with the third action.

In the fourth action, the piezoelectric actuator corresponding to the second pump device 1204 is contracted by applying a continuously variable voltage less than 100V, which will allows the second pump chamber 1244 to expand. The applied voltage is controlled, e.g., using the strain gauges of the piezoelectric actuators corresponding to the first and second pump devices 1202 and 1204, to pump a continuous flow of fluid at the desired magnitude. Because the first pump chamber 1242 is producing greater flow of the fluid than the desired flow, the second pump chamber 1244 will be filling with fluid during the fourth action. The integrated fluid transfer device 1200 is thus able to provide a continuous flow.

Of course, various alternative configurations and/or arrangements of one or more fluid transfer devices may be incorporated without departing from the scope of the present teachings. For example, a fluid transfer device may include one inlet valve device followed by multiple interconnected pump devices followed by one outlet valve device. This configuration multiplies the displacement volume of a pump chamber in a single pump device by however many pump devices are included between the inlet and outlet valve devices. Multiple interconnected pump devices has an advantage over simply increasing the lateral size of a single pump chamber, which may decrease stiffness of the flexible membrane in the pump device, rendering it more susceptible to undesirable mechanical deformation at high back pressures.

Further, multiple fluid transfer devices, e.g., configured in accordance with one or more of the embodiments discussed herein, may be connected together, in parallel and/or series combinations, to provide additional benefits. For example, the multiple fluid transfer devices may be connected in parallel, where corresponding device inlet ports are connected to each other and corresponding device outlet ports are connected to each other. The individual fluid transfer devices may then be actuated synchronously or asynchronously. Synchronized actuation increases volumetric flow rate by multiplying the flow rate of a single fluid transfer device by however many fluid transfer devices are connected to one another in parallel. Asynchronous (or staggered) actuation may dampen pulsation for continuous flow and/or generate arbitrarily time-varying flow rates, for example.

Likewise, the multiple fluid transfer devices may be connected in series, where multiple inlet and outlet valve devices, separated from one another by one or more pump devices, are configured such that the outlet port of each outlet valve device is connected to the inlet port of a succeeding inlet valve device. This staged configuration enables pumping against higher pressures. Each corresponding pump chamber(s) of the interconnected fluid transfer devices would incrementally add its individual maximum achievable pressure to the pressure generated by the pump chamber(s) of the previous fluid transfer device(s). Therefore, the maximum achievable pressure would be equal the sum of the maximum achievable pressures of the constituent equivalent transfer devices.

While specific embodiments are disclosed herein, many variations are possible, which remain within the concept and scope of the invention. Such variations would become clear after inspection of the specification, drawings and claims herein. The invention therefore is not to be restricted except within the scope of the appended claims.

What is claimed is:

1. A fluid transfer device, comprising:
a piezoelectric actuator externally coupled to a microfluidic device, the piezoelectric actuator having an axial displacement along a lengthwise axis responsive to application of a bias voltage, the axial displacement of the piezoelectric actuator operating one of an internal valve and an internal pump chamber of the microfluidic device.

2. The device of claim 1, further comprising:
a high-stiffness actuator coupled to the piezoelectric actuator, and configured to dynamically adjust a position of the piezoelectric actuator relative to the microfluidic device.

3. The device of claim 1, wherein the axial displacement of the piezoelectric actuator is less than about 10 μm.

4. The device of claim 1, wherein the bias voltage is applied to the piezoelectric actuator in a periodic fashion to cause the one of the internal valve and the internal pump chamber to enable fluid pumping functionality.

5. The device of claim 1, wherein the bias voltage is applied to the piezoelectric actuator continuously to maintain a constant axial displacement and to cause the one of the internal valve and the internal pump chamber to provide flow restriction functionality.

6. A fluid transfer device, comprising:
a microfluidic device comprising a first valve having a valve chamber, operation of the first valve enabling fluid to enter or exit the valve chamber through a port; and
a first piezoelectric actuator coupled to the microfluidic device, and configured to extend along a first lengthwise axis in response to application of a first bias voltage to close the first valve, and to contract along the first lengthwise axis in response to a reduction of the applied first bias voltage to open the first valve, wherein the first piezoelectric actuator is external to the microfluidic device.

7. The device of claim 6, wherein the first piezoelectric actuator comprises one of a stacked piezoelectric actuator or a piezoelectric tube.

8. The device of claim 6, further comprising:
a high-stiffness actuator coupled to the piezoelectric actuator, and configured to adjust a position of the piezoelectric actuator in relation to the microfluidic device, wherein the high-stiffness actuator is external to the microfluidic device.

9. The device of claim 8, wherein the high-stiffness actuator comprises an adjustable screw-drive configured to adjust the position of the piezoelectric actuator along the lengthwise axis, the adjustable screw-drive comprising a rotary motor coupled to a fine-pitch screw in contact with the piezoelectric actuator.

10. The device of claim 8, further comprising:
a strain gauge positioned between the first piezoelectric actuator and the high-stiffness actuator, the stain gauge being configured to detect compression of the first piezoelectric actuator and to provide feedback to the high-stiffness actuator for adjusting the position of the first piezoelectric actuator in relation to the microfluidic device based on the detected compression.

11. The device of claim 6, wherein the microfluidic device further comprises a pump chamber fluidly connected to the valve chamber via a port, operation of the first valve enabling fluid to enter or exit the pump chamber through the port.

12. The device of claim 11, further comprising:
a second piezoelectric actuator coupled to the microfluidic device, and configured to extend and contract along a second lengthwise axis in response to selective application of a second bias voltage to compress and expand the pump chamber, wherein the second piezoelectric actuator is external to the microfluidic device.

13. The device of claim 11, wherein at least one of the pump chamber and the valve chamber comprises a raised pattern configured to arrest growth of droplets as the fluid enters the at least one of the pump chamber and the valve chamber.

14. The device of claim 11, wherein at least one of the pump chamber and the valve chamber comprises a depressed pattern configured to arrest growth of droplets as the fluid enters the at least one of the pump chamber and the valve chamber.

15. The device of claim 11, wherein at least one of the pump chamber and the valve chamber comprises a gas permeable membrane configured to enable air bubbles trapped in the fluid to exit the at least one of the pump chamber and the valve chamber.

16. The device of claim 11, wherein internal walls of the microfluidic device and the at least one of the pump chamber and the valve chamber are coated with a non-reactive coating.

17. A combination fluid transfer device comprising one of the fluid transfer device of claim 11 connected in parallel or series with another one of the fluid transfer device of claim 11.

18. The device of claim 6, wherein the microfluidic device further comprises a second valve having a valve chamber fluidly connected to the valve chamber of the first valve via a port, operation of the second valve enabling fluid to enter or exit the valve chamber of the second valve through the port, and
wherein the device further comprises a second piezoelectric actuator coupled to the microfluidic device, and configured to extend along a second lengthwise axis in response to application of a second bias voltage to close the second valve, and to contract along the second lengthwise axis in response to a reduction of the applied second bias voltage to open the second valve, wherein the second piezoelectric actuator is external to the microfluidic device.

19. A fluid transfer device, comprising:
a microfluidic device comprising one of a pump chamber and a valve chamber defined, in part, by a flexible membrane; and
a piezoelectric actuator coupled to the microfluidic device, and configured to extend along a lengthwise axis in response to application of a bias voltage, the value of the bias voltage moving the flexible membrane to a position that compresses the one of the pump chamber and the valve chamber for restricting flow of a fluid through the microfluidic device at a desired flow rate, wherein the piezoelectric actuator is external to the microfluidic device.

20. The fluid transfer device of claim 19, further comprising:
a controller configured to determine an extension of the piezoelectric actuator corresponding to the desired flow rate, and to control application of the bias voltage to the piezoelectric actuator to move the flexible membrane to the position that restricts the flow of the fluid through the microfluidic device to the desired flow rate.
